(19) United States
(12) Patent Application Publication
(10) Pub. No.: US 2018/0094181 A1
(43) Pub. Date: Apr. 5, 2018

(54) COMPOSITE MATERIAL AND PRODUCTION METHOD THEREOF, AND HEAT CONDUCTIVE MATERIAL

(71) Applicants: National Institute of Advanced Industrial Science and Technology, Tokyo (JP); Fuji Polymer Industries Co., Ltd., Nagoya-shi (JP)

(72) Inventors: Yuichi TOMINAGA, Aichi (JP); Kimiyasu SATO, Aichi (JP); Yuji HOTTA, Aichi (JP); Mai SUGIE, Aichi (JP); Hitoshi SHIBUYA, Aichi (JP); Toshio SARUYAMA, Aichi (JP)

(21) Appl. No.: 15/704,827

(22) Filed: Sep. 14, 2017

(30) Foreign Application Priority Data
Oct. 3, 2016 (JP) 2016-195778

(51) Int. Cl. C09K 5/14; D21H 19/12; D21H 17/67

(52) U.S. Cl. CPC C09K 5/14; D21H 17/67; D21H 19/12

(57) ABSTRACT

A composite material of the present invention is a composite material including cellulose nanofibers and nanoparticles. The structure of the nanoparticles is composed of primary nanoparticles with a particle diameter of 3 to 50 nm or aggregated nanoparticles with a particle diameter of 100 nm or less in which the nanoparticles are aggregated. The surfaces of the cellulose nanofibers are densely covered with the nanoparticles. The composite material has a thermal conductivity in a plane direction of preferably 3.0 W/m·K or more. The production method of the composite material of the present invention includes continuously or sequentially mixing a suspension in which cellulose nanofibers are dispersed in a dispersion medium and a suspension in which nanoparticles are dispersed in a dispersion medium to obtain a composite material in which the surfaces of the cellulose nanofibers are densely covered with the nanoparticles.

### BACKGROUND OF THE INVENTION

### 1. Field of the Invention

The present invention relates to a composite material in which the surfaces of cellulose nanofibers are densely covered with nanoparticles, and a production method thereof, and a use thereof.

### 2. Description of Related Art

Cellulose nanofibers are biomass materials that can be obtained by fining cellulose fibers constituting plants to a nano-level. The cellulose nanofibers are light and strong, and comparable in tensile strength and elastic modulus to aramid fibers, which are known as high-strength fibers. Since the cellulose nanofibers are derived from plants, their environmental loads in the production process and disposal are low and their use in various fields has been studied. The cellulose nanofibers densely contain functional groups such as a hydroxyl group on their surfaces, and have a large specific surface area of 100 m²/g or more. Therefore, the cellulose nanofibers have been studied to be combined with other materials by arranging other materials on the surfaces of the cellulose nanofibers to produce new functions.

Patent Document 1 proposes a nano-composite material in which spherical inorganic compounds are connected like a rosary, with nano-fibrous polysaccharide (e.g., cellulose nanofiber) being centered. Materials of the nanoparticles that can be used in Patent Document 1 are limited to materials that can be decomposed or dissolved by aqueous counter collision and thereafter aggregate or crystallize. These materials are limited to carbonates and sulfates of alkaline earth metals. Since the inorganic compounds that can be formed into the nanoparticles are limited, functions of the nano-composite materials to be obtained are limited. Patent Document 2 proposes a composition including a matrix resin, a silicon compound or metal compound, and polymer fibers (e.g., cellulose nanofibers). Patent Document 2 indicates that a sol-gel method is a method of producing an oxide or a hydroxide from hydrolysis or dehydration of a precursor (e.g., metal alkoxide). A resultant obtained by the sol-gel method is a continuous layer of a silicon oxide or metal oxide, and has a structure in which the silicon oxide layer or metal oxide layer covers the polymer fibers. Patent Document 2 does not aim to produce nanoparticles, as no nanoparticles were produced in examples. In other words, Patent Document 2 does not have a technical idea of covering the polymer fibers with nanoparticles. Moreover, since materials obtained by the sol-gel method have low crystallinity, properties inherent in the materials cannot be fully exhibited, and functions of a composition to be obtained are limited to a very narrow range. In Patent Documents 3-4, some of the present inventors propose a new composition that can significantly improve conduction properties and thermal conduction properties and impart anisotropy and transparency by causing a material having a size equivalent to the diameter of cellulose nanofibers to adsorb on the surfaces of the cellulose nanofibers. Examples of the material include graphenes with a nano-order thickness, and thermal conductive particles with a diameter of tens of nanometers. However, in this composition, the degree of adsorption of the nanomaterial on the surfaces of the cellulose nanofibers varies. Further, this composition includes an area where the nanomaterial does not adsorb on the surfaces of the cellulose nanofibers, so that part of the surfaces of the cellulose nanofibers is exposed.

### PRIOR ART DOCUMENTS

### Patent Documents

[Patent Document 1] JP 2015-071843 A

[Patent Document 2] JP 2008-248033 A

[Patent Document 3] WO 2016/043145 A1

[Patent Document 4] WO 2016/043146 A1

### SUMMARY OF THE INVENTION

The electric conduction properties and thermal conduction properties are increased by eliminating the roughness and defects in electric and thermal paths and increasing the number of such paths. In order for a composition containing cellulose nanofibers to maximize the conduction properties and thermal conduction properties, it is necessary to establish a structure in which a nanomaterial that forms such paths densely covers the entire surfaces of the cellulose nanofibers. The products of the conventional arts do not sufficiently have such properties, and are required to be modified.

The present invention has been achieved in view of the above circumstances, and its object is to provide a composite material having high thermal conduction properties in which the surfaces of cellulose nanofibers are densely covered with nanoparticles or aggregated nanoparticles, a production method thereof, and a thermal conductive material.

A composite material of the present invention is a composite material including cellulose nanofibers and nanoparticles. The structure of the nanoparticles is composed of primary nanoparticles with a particle diameter of 3 to 50 nm or aggregated nanoparticles with a particle diameter of 100 nm or less in which the nanoparticles are aggregated. The surfaces of the cellulose nanofibers are densely covered with the nanoparticles.

A method for producing a composite material of the present invention is a method for producing a composite material including cellulose nanofibers and nanoparticles. The method includes: continuously or sequentially mixing a suspension in which cellulose nanofibers are dispersed in a dispersion medium and a suspension in which nanoparticles are dispersed in a dispersion medium to obtain a composite material including the cellulose nanofibers and the nanoparticles. The structure of the nanoparticles is composed of primary nanoparticles with a particle diameter of 3 to 50 nm or aggregated nanoparticles with a particle diameter of 100 nm or less in which the nanoparticles are aggregated. The surfaces of the cellulose nanofibers are densely covered with the nanoparticles.

A thermal conductive material of the present invention is a thermal conductive material including cellulose nanofibers and nanoparticles. The structure of the nanoparticles is composed of primary nanoparticles with a particle diameter of 3 to 50 nm or aggregated nanoparticles with a particle diameter of 100 nm or less in which the nanoparticles are aggregated. The surfaces of the cellulose nanofibers are densely covered with the nanoparticles.

The composite material of the present invention has a configuration in which the surfaces of cellulose nanofibers are densely covered with nanoparticles, thereby having many thermal conductive paths with less defects and exhibiting high thermal conduction properties.

### BRIEF DESCRIPTION OF THE DRAWINGS

FIG. 1 is a scanning electron microscope (SEM at 50000× magnification) photograph of an internal microstructure of a film sample formed from a composite material produced in Examine 1 of the present invention.

FIG. 2 is a scanning electron microscope (SEM at 50000× magnification) photograph of an internal microstructure of a film sample formed from a composite material produced in Examine 5 of the present invention.

FIG. 3 is a schematic diagram illustrating steps of producing a composite material using a coprecipitation method in one example of the present invention.

FIG. 4 is a schematic diagram illustrating steps of producing a composite material using a simultaneous processing method that combines integration and disk mill coprecipitation in another example of the present invention.

### DETAILED DESCRIPTION OF THE INVENTION

The composite material of the present invention includes cellulose nanofibers and nanoparticles. The structure of the nanoparticles is composed of primary nanoparticles with a particle diameter of 3 to 50 nm or aggregated nanoparticles with a particle diameter of 100 nm or less in which the nanoparticles are aggregated. The surfaces of the cellulose nanofibers are densely covered with the nanoparticles. Thereby, defects are reduced and thermal conductivity is enhanced. Here, the “densely covered with” refers to a state in which the surfaces of the cellulose nanofibers are covered with the nanoparticles to the extent that the surfaces of the cellulose nanofibers cannot be seen by the observation with a scanning electron microscope (SEM at 50000× magnification).

Preferably, the composite material has a thermal conductivity in a plane direction of 3.0 W/m·K or more. Since the thermal conductivity is conventionally about 2.7 W/m·K, the composite material of the present invention is superior in thermal conductivity.

Preferably the nanoparticles are at least one selected from the group consisting of diamond, boron nitride, aluminum nitride, silicon nitride, silicon carbide, beryllium oxide, aluminum oxide, zinc oxide, magnesium oxide, silicon oxide, titanium oxide, aluminum hydroxide, and magnesium hydroxide. With this, the material can have high thermal conductivity.

Since the cellulose nanofibers need to have a sufficiently large specific surface area and be dispersed in the aqueous solvent and/or organic solvent, they preferably have an aspect ratio of 50 to 200. In the present specification, “aspect ratio” means a value estimated from a liquid phase precipitation method for nanofibers (L. Zhang et al., Cellulose, Vol. 19, page 561, 2012). Specifically, the aspect ratio is a value calculated from the following formula using the initial concentration of nanofibers dispersed in a solution layer and a linear term coefficient derived from an approximate expression of the precipitation height: 1/A²=4 g/33 πρ (A: aspect ratio, g: linear term coefficient derived from an approximate expression, ρ: nanofiber density). In many cases, the aspect ratio of cellulose nanofibers is less than 50. To adjust the aspect ratio to be 50 to 200, a method of fining fibers by applying a high shearing force to a dispersion of the cellulose nanofibers is preferably used. The method of applying a high shearing force is not particularly limited, but fining fibers by wet disk milling is one of the preferable methods. The wet disk milling is a processing method of fining fibers by introducing a solvent and fibers between two opposing disks while rotating the disks Y. Tominaga et. al, J. Ceram. Soc. Jpn. Vol. 123, page 512, 2015). The “high shearing force” described above is a shearing force of 0.1 MPa to 500 MPa.

The mass ratio of the cellulose nanofibers to the nanoparticles of the composite material is preferably 1:0.5 to 1:5, more preferably 1:0.8 to 1:4. Within this range, high thermal conduction properties are obtained.

The production method of the composite material of the present invention includes continuously or sequentially adding a suspension in which cellulose nanofibers are dispersed in a dispersion medium and a suspension in which nanoparticles are dispersed in a dispersion medium, and mixing them simultaneously to obtain a composite material in which the surfaces of the cellulose nanofibers are densely covered with the nanoparticles. Preferably, cellulose nanofibers and nanoparticles that are well dispersed in separate solvents in advance are caused to gradually approach and come into contact with each other in a dilute solution to make the nanoparticles densely cover the surfaces of the cellulose nanofibers. Specifically, the cellulose nanofibers well dispersed in a solvent and the nanoparticles well dispersed in a solvent are, separately or simultaneously, gradually added into a large amount of a solvent dropwise, and they are mixed at a low solid content to prevent aggregation between the nanoparticles and between the cellulose nanofibers, so that the nanoparticles and the cellulose nanofibers can come into contact with each other.

A mixed solution of the suspensions at the time of continuously or sequentially mixing the suspensions is a dilute solution having a solid content of preferably 3 mass % or less, more preferably 1 mass %. By using such a dilute solution, a composite material to be obtained can have high thermal conduction properties.

Both of the suspensions may be continuously or sequentially mixed into a base dispersion medium at the time of mixing the suspensions. The base dispersion medium is an aqueous solvent or an organic solvent. By using the base dispersion medium, the solid content of the suspensions can be kept low and the concentration change is prevented.

The suspension of the cellulose nanofibers has a solid content of 0.1 to 3 mass %, preferably 0.3 to 2.5 mass %. The suspension of the nanoparticles has a solid content of 0.1 to 10 mass %, preferably 0.2 to 8 mass %. Within the above ranges, the solid content can be kept low.

Preferably a mixed solution of the suspensions has a pH of 4 to 9. Within the above range, a composite material to be obtained can have high thermal conduction properties.

Preferably, a high shearing force of 0.1 to 500 MPa is applied at the time of mixing the suspension of the cellulose nanofibers and the suspension of the nanoparticles. With this high shearing force, high thermal conduction properties can be obtained efficiently.

A dry thin film of the composite material in which the surfaces of the cellulose nanofibers are densely covered with the nanoparticles is obtained by removing the dispersion medium of the composite material. Preferably, the dispersion medium of the composite material is removed by filtration. The dispersion medium can be removed efficiently by filtration.

Preferably the filtration is suction filtration or pressure filtration. The dispersion medium can be removed more efficiently by suction filtration or pressure filtration.

The pressing may be performed after the filtration. The pressing can prevent the deformation of the film.

Since the thermal conductive material including the composite material of the present invention has voids, it can pass gas and liquid easily and remove heat of a heat generating portion efficiently. Therefore, the thermal conductive material can be used for the purpose of removing heat from, e.g., a semiconductor efficiently.

Hereinafter, the production method of the present invention will be described following the order of steps.

(1) First Step

The first step of producing a composite material of the present invention is a step of dispersing cellulose nanofibers and nanoparticles in dispersion mediums selected from an aqueous solvent and an organic solvent.

Any aqueous solvent and/or organic solvent that can disperse the cellulose nanofibers and the nanoparticles may be used as the aqueous solvent and/or organic solvent for dispersing the cellulose nanofibers and the nanoparticles. The aqueous solvent may contain ions to adjust pH and ion intensity Examples of the organic solvent include chloroform, dichloromethane, carbon tetrachloride, acetone, methyl ethyl ketone, methyl isobutyl ketone, diisobutyl ketone, methyl acetate, ethyl acetate, propyl acetate, isopropyl acetate, butyl acetate, isobutyl acetate, pentyl acetate, isopentyl acetate, amyl acetate, tetrahydrofuran, N-methyl-2-pyrrolidone, dimethylformaldehyde, dimethylacetamide, dimethylsulfoxide, acetonitrile, methanol, ethanol, propanol, isopropanol, butanol, hexanol, octanol, hexafluoroisopropanol, ethylene glycol, propylene glycol, tetramethylene glycol, tetraethylene glycol, hexamethylene glycol, diethylene glycol, benzene, toluene, xylene, chlorobenzene, dichlorobenzene, trichlorobenzene, chlorophenol phenol, sulfolane, 1,3-dimethyl-2-imidazolidinone, γ-butyrolactone, N-dimethylpyrrolidone, pentane, hexane, neopentane, cyclohexane, heptane, octane, isooctane, nonane, decane, and diethyl ether. The solvent may be used alone or in combinations of two or more.

The structure of the nanoparticles is composed of primary nanoparticles with a particle diameter of 3 to 50 nm or aggregated nanoparticles with a particle diameter of 100 nm or less in which the nanoparticles are aggregated.

The material of the nanoparticles is at least one selected from the group consisting of diamond, boron nitride, aluminum nitride, silicon nitride, silicon carbide, beryllium oxide, aluminum oxide, zinc oxide, magnesium oxide, silicon oxide, titanium oxide, aluminum hydroxide, and magnesium hydroxide.

(2) Second Step

The second step of producing a composite material of the present invention is a step of continuously or sequentially mixing a suspension in which the cellulose nanofibers are dispersed in the aqueous solvent and/or organic solvent and a suspension in which the nanoparticles are dispersed in the aqueous solvent or organic solvent, thereby obtaining a structure in which the surfaces of the cellulose nanofibers are densely covered with the nanoparticles.

As the method of mixing two kinds of the suspensions, a method of gradually adding the suspensions into an excess amount of water or a solvent (base dispersion medium) is preferred (hereinafter, referred to as a “dispersion system”). It is more preferred that the dispersion system have a solid content of 3 mass % or less to produce dense structure of the nanoparticles. The pH of the dispersion system is preferably kept in a range where the charge of the nanoparticles and the charge of the cellulose nanofibers are reversed. For example, the pH of the dispersion system is kept in a range where the surface potential of nanodiamond structures becomes positive and the surface potential of the cellulose nanofibers becomes negative. The surface potential is determined by measuring the zeta-potential of the respective dispersions. When preparing the dispersion system by gradually adding the suspensions into an excess amount of water or a solvent, it is preferable to apply a high shearing force to the dispersion system.

(3) Third Step

The third step of producing a composite material of the present invention is a step of removing the solvent from the suspension containing a composite material in which the surfaces of the cellulose nanofibers are densely covered with the nanoparticles, and forming the composite material into a desired shape.

As the method of removing the solvent from the suspension containing a composite material and forming the composite material into a desired shape, it is preferable to perform filtration rather than to cast the suspension containing a composite material and dry it naturally. It is more preferable to perform suction filtration, pressure filtration, centrifugal filtration, or the like, in terms of producing high thermal conductive films. It is preferable to perform pressing, more preferably vacuum pressing and heat drying, in terms of more sufficiently drying the structures and preventing the deformation of films, and to further perform pressing to prevent the deformation of the structures more reliably. The composite material containing the cellulose nanofibers and the nanoparticles of the present invention is generally a porous material. By utilizing this porousness, the composite material can be used as a high thermal conductive material that can pass gas and liquid. Moreover, it also can be used as a composite by impregnating the obtained composite material with a polymer material. The polymer material can be widely selected from, e.g., thermoplastic resins and thermosetting resins, examples of which include, but are not limited to, acrylic resin, epoxy resin, phenolic resin, nylon resin, ABS resin, PET, PBT, polytetrafluoroethylene, polyvinyl chloride, polystyrene, polyethylene, polypropylene, polyamide, polyimide, polycarbonate, polyester, polyacetal, polyethylene glycol, polyethylene oxide, polyacrylic acid, polyacrylic ester, polymethacrylate, polyvinyl alcohol, melamine resin, silicone resin, epoxy resin, urethane, and silicone. In the case of using the thermosetting resin, it is desired that the composite material be firstly impregnated with the resin and then cured.

Any additives such as a plasticizer, a flame retarder, an antioxidant, and an ultraviolet absorber can be added to the composite material containing the cellulose nanofibers and the nanoparticles, as long as the nature of the composite material is not impaired. These additives may be added to the dispersions or added later by immersion utilizing the porousness of the produced composite material.

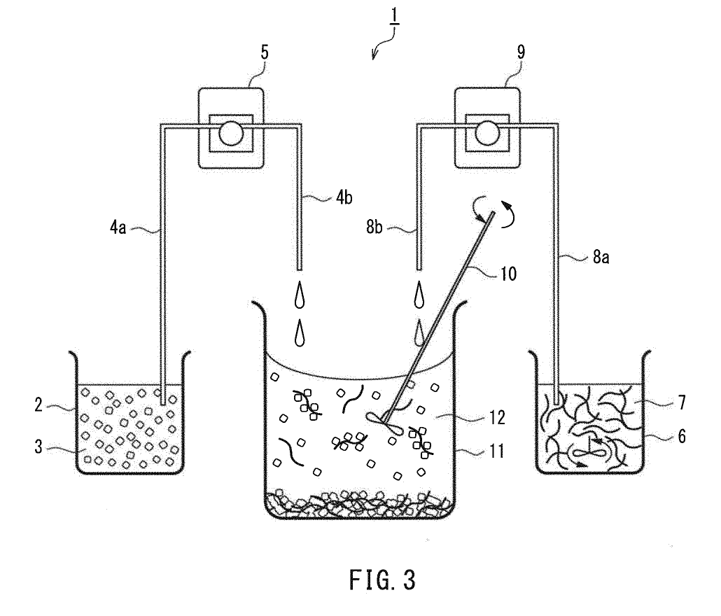

Hereinafter, the present invention will be described with reference to the drawings. FIG. 3 is a schematic diagram illustrating steps of producing a composite material using a coprecipitation method in one example of the present invention. In a coprecipitation and integration device 1, 300 mL of ultrapure water (solvent) is stored in a container 11 and stirred with a stirrer 10 in advance. A dispersion 3 of nanodiamond in a container 2 is supplied dropwise into the container 11 via tubes 4a and 4b using a tube pump 5. Meanwhile, an aqueous dispersion 7 of the cellulose nanofibers in a container 6 is supplied dropwise into the container 11 via tubes 8a and 8b using a tube pump 9. By mixing these inside the container 11, a dispersion 12 containing a composite material including the cellulose nanofibers and the nanoparticles is obtained.

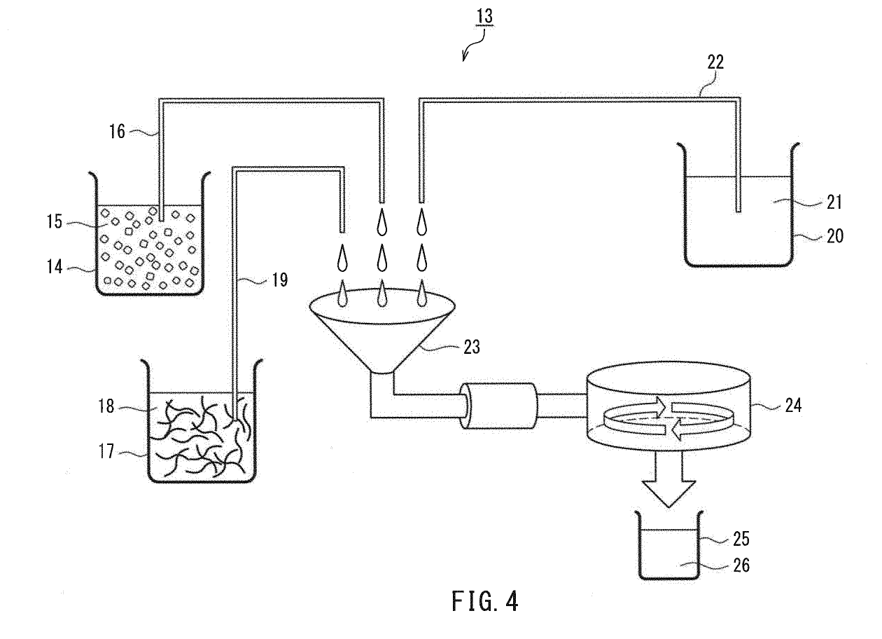

FIG. 4 is a schematic diagram illustrating steps of producing a composite material using a simultaneous processing method that combines integration and disk milling in another example of the present invention. In an integration and disk milling simultaneous processing device 13, a dispersion 15 of the nanoparticles in a container 14 is supplied to a liquid receiver 23 from a supply tube 16, a dispersion 18 of the cellulose nanofibers in a container 17 is supplied to the liquid receiver 23 from a supply tube 19, and ultrapure water 21 in a container 20 is supplied to the liquid receiver 23 from a supply tube 22. The dispersions 15, 18 and the ultrapure water 21 in the liquid receiver 23 are simultaneously introduced into a wet disk mill 24, and a resultant is collected in a container 25 as a dispersion 26 of a composite material.

### EXAMPLES

Hereinafter, the present invention is more specifically described by way of examples. However, the following examples only indicate part of the embodiments of the present invention, and hence, the present invention shall not be interpreted to be limited to the following examples.

The content of nanodiamond and that of cellulose nanofibers in a composite material film were determined by a thermogravimetric measurement.

The void ratio in the composite material was calculated from the mass and the size of the film.

The thermal conductivity in an in-plane direction of the film was measured in accordance with the cyclic heating method using a thermowave analyzer TA 33 manufactured by Bethel.

### Example 1

2.5 g of nanoparticles (diameter: 20 nm) constituted by diamond particles (single particle diameter: 5 nm) was mixed with 47.5 g of ultrapure water, and subjected to wet disk milling to prepare 25 g of a dispersion of the nanoparticles having a solid content of 5 mass % and a pH of 5.

An aqueous dispersion (solid content: 0.5 mass %) of cellulose nanofibers (average fiber diameter: 100 nm) was fined with a shearing force of 70 MPa by wet disk milling. Thus, cellulose nanofibers having an average fiber diameter of 50 nm and an aspect ratio of 110 were obtained. The pH of the aqueous dispersion of the cellulose nanofibers having an aspect ratio of 110 was adjusted with sodium hydroxide to prepare 50 g of a dispersion of the cellulose nanofibers having a solid content of 0.8 mass % and a pH of 10.

The coprecipitation and integration device illustrated in FIG. 3 was used. 300 mL of ultrapure water was poured into a container. While the ultrapure water was stirred at a rotation speed of 150 rpm, 25 g of the dispersion of the nanoparticles and 50 g of the dispersion of the cellulose nanofibers were supplied drop wise into the container at speeds of 5 mL/hour and 10 mL/hour, respectively. By this mixing step, a dispersion containing a composite material including the cellulose nanofibers and the nanoparticles was obtained. The dispersion of the composite material had a solid content of the diamond particles of 0.3 mass %, that of the cellulose nanofibers of 0.1 mass %, and that of the composite material of 0.4 mass %.

The dispersion of the composite material obtained was subjected to suction filtration under 2 kPa to remove the solvent. A filter cake obtained was vacuum pressed under 600 kgf/cm² at 70° C. for 20 minutes, dried at 100° C. in the atmosphere, and further vacuum pressed under 600 kgf/cm² at 70° C. for 20 minutes to produce a film formed from the composite material.

(Evaluation)

The composite film thus produced was analyzed by a thermogravimetric measurement. The mass ratio of the nanodiamond to the cellulose nanofiber in the film was calculated from the measurement results.

The percentage of pores (void ratio) in the film was calculated from the mass and the size of the film.

The thermal conductivity in an in-plane direction of the film was evaluated in accordance with the cyclic heating method using a thermowave analyzer TA 33 manufactured by Bethel.

The composite material film obtained had a nanodiamond/cellulose nanofiber ratio of 2:1 (mass ratio), a void ratio of 50 vol %, and a thermal conductivity in a plane direction of 4.5 W/m·K, resulting in high thermal conduction properties.

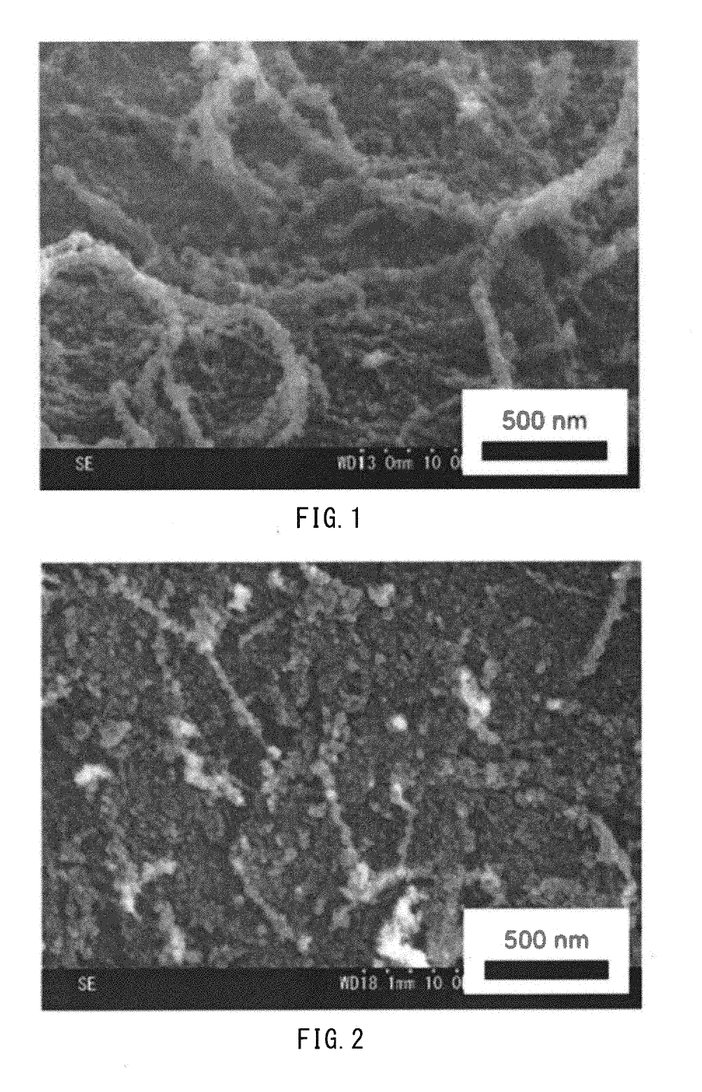

The observation result of the microstructure of the composite material film by a scanning electron microscope (SEM) was shown in FIG. 2. It was confirmed that the film was constituted by the composite material in which the surfaces of the cellulose nanofibers were densely covered with the diamond nanoparticles. The SEM photograph of the composite film obtained is shown in FIG. 1.

### Example 2

A film formed from a composite material was produced in the same manner as in Example 1 after the stirring step inside the container, except that the dispersion of the nanoparticles was not subjected to the wet disk milling.

The composite material film obtained had a nanodiamond/cellulose nanofiber ratio of 1.6:1 (mass ratio), a void ratio of 40 vol %, and a thermal conductivity in a plane direction of 3.7 W/m·K, resulting in high thermal conduction properties. High thermal conductivity was obtained without applying a high shearing force to the dispersion of the nanoparticles.

### Example 3

A film formed from a composite material was produced in the same manner as in Example 2, except that the amount of the dispersion of the nanoparticles was changed to 42 g, and the dropping rate of the dispersion into the container was changed to 9 mL/hour.

The composite material film obtained had a nanodiamond/cellulose nanofiber ratio of 2:1 (mass ratio), a void ratio of 51 vol %, and a thermal conductivity in a plane direction of 3.1 W/m·K, resulting in high thermal conduction properties. High thermal conductivity was obtained even when the dropping rate of the dispersion of the nanoparticles into the container was increased.

### Example 4

A film formed from a composite material was produced in the same manner as in Example 2, except that the amount of the dispersion of the nanoparticles was changed to 9 g, and the dropping rate of the dispersion into the container was changed to 2 ml/hour.

The composite material film obtained had a nanodiamond/cellulose nanofiber ratio of 1:1 (mass ratio), a void ratio of 46 vol %, and a thermal conductivity in a plane direction of 3.2 W/m·K, resulting in high thermal conduction properties. High thermal conductivity was obtained even when the dropping rate of the dispersion of the nanoparticles into the container was decreased.

### Example 5

A dispersion of the composite material was prepared in the same manner as in Example 2, except that the integration and disk milling simultaneous processing device illustrated in FIG. 4 was used, and 25 g of the dispersion of the nanoparticles, 50 g of the dispersion of the cellulose nanofibers, and 300 mL of ultrapure water were simultaneously introduced into the wet disk mill and processed. The processing conditions of the wet disk mill were as follows: a distance between disks: 100 μm, a rotation speed of the disks: 10000 rpm (shearing force: 70 MPa). The introducing rate of the dispersion of the nanoparticles to the wet disk mill was 6 mL/minute, that of the dispersion of the cellulose nanofibers was 11 mL/minute, and that of the ultrapure water was 67 mL/minute.

The dispersion of the composite material obtained was subjected to pressure filtration under 0.4 MPa to remove the solvent. A filter cake obtained was vacuum pressed under 600 kgf/cm² at 70° C. for 20 minutes, dried at 100° C. in the atmosphere, and further vacuum pressed under 600 kgf/cm² at 70° C. for 20 minutes to produce a film formed from the composite material.

The composite material film obtained had a nanodiamond/cellulose nanofiber ratio of 3.1:1 (mass ratio), a void ratio of 54 vol %, and a thermal conductivity in a plane direction of 3.7 W/m·K, resulting in high thermal conduction properties. The thermal conductivity of the composite material film of Example 6 was the same as that of the composite material film of Example 2. It is considered that the thermal conductivity of the composite material film is independent of the production conditions. The SEM photograph of the obtained composite film was shown in FIG. 2.

### Example 6

A dispersion of the composite material was prepared in the same manner as in Example 6, except that the amount of the dispersion of the nanoparticles was changed to 42 g, and the introduction rate of the dispersion was changed to 9 mL/minute.

The dispersion of the composite material obtained was subjected to suction filtration under 2 kPa to remove the solvent. A filter cake obtained was vacuum pressed under 600 kgf/cm² at 70° C. for 20 minutes, dried at 100° C. in the atmosphere, and further vacuum pressed under 600 kgf/cm² at 70° C. for 20 minutes to produce a film formed from the composite material.

The composite material film obtained had a nanodiamond/cellulose nanofiber ratio of 3.8:1 (mass ratio), a void ratio of 63 vol %, and a thermal conductivity in a plane direction of 3.4 W/m·K, resulting in high thermal conduction properties.

### Example 7

A dispersion of the composite material was prepared in the same manner as in Example 2, except that cellulose nanofibers having an average fiber diameter of 100 nm and an aspect ratio of 80 were used.

The dispersion of the composite material obtained was subjected to suction filtration under 2 kPa to remove the solvent. A filter cake obtained was vacuum pressed under 1200 kg/cm² at 70° C. for 20 minutes, and dried at 100° C. in the atmosphere to produce a film formed from the composite material.

The composite material film obtained had a void ratio of 46 vol %, and a thermal conductivity in a plane direction of 3.3 W/m·K, resulting in high thermal conduction properties.

### Comparative Example 1

0.5 g of the dispersion of the nanoparticles, 0.5 g of the dispersion of the cellulose nanofibers, and 99 mL of ultrapure water were mixed simultaneously and stirred for 30 seconds with a rotation and revolution mixer. The dispersion of the composite material obtained was subjected to suction filtration under 2 kPa to remove the solvent. A filter cake obtained was vacuum pressed under 600 kgf/cm² at 70° C. for 20 minutes, dried at 100° C. in the atmosphere, and further vacuum pressed under 600 kgf/cm² at 70° C. for 20 minutes to produce a film formed from the composite material.

The composite material film obtained had a void ratio of 46 vol %, and a thermal conductivity in a plane direction of 1.7 W/m·K, resulting in low thermal conduction properties. It is considered that a dense composite structure cannot be formed when the dispersion of the nanoparticles and the dispersion of the cellulose nanofibers are mixed simultaneously.

### Comparative Example 2

10 g of the same aqueous dispersion of the nanodiamonds as that in Example 1 and 65 g of ultrapure water were added to 25 g of the same aqueous dispersion of the cellulose nanofibers as that in Example 1, and they were mixed with a centrifugal mixer for 30 seconds to prepare a composition dispersion. 10 g of the composition dispersion was filtered under reduced pressure using a membrane filter (pore: 0.8 μm) to separate a liquid component. A composition film was peeled off from the membrane filter and subjected to pressure molding at 70° C. under a pressure of 30 kgf/cm² for 20 minutes. Thus, a smooth film was obtained.

The composite material film obtained had a nanodiamond/cellulose nanofiber ratio of 1:1 (mass ratio), a void ratio of 47.4 vol %, and a thermal conductivity in a plane direction of 2.7 W/m·K, resulting in low thermal conduction properties. It is considered that a dense composite structure cannot be formed when the dispersion of the nanoparticles and the dispersion of the cellulose nanofibers are mixed simultaneously.

### INDUSTRIAL APPLICABILITY

The present invention enables formation of a composite material in which the surfaces of cellulose nanofibers are densely covered with nanoparticles. The composite material obtained by the present invention can be used as a microelectronics member or an optical device material (e.g., an LED sealing material) with excellent electrical insulation properties and/or high thermal conduction properties.

### DESCRIPTION OF REFERENCE NUMERALS

1 coprecipitation and integration device
2, 6, 11, 14, 17, 20, 25 container
3, 15 dispersion of nanodiamond
4a, 4b, 8a, 8b, 16, 19, 22 tube
5, 9 tube pump
7, 18 aqueous dispersion of cellulose nanofibers
10 stirrer
12, 26 dispersion of composite material
13 integration and disk milling simultaneous processing device
21 ultrapure water
23 liquid receiver
24 wet disk mill

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A composite material comprising cellulose nanofibers and nanoparticles,
wherein the structure of the nanoparticles is composed of primary nanoparticles with a particle diameter of 3 to 50 nm or aggregated nanoparticles with a particle diameter of 100 nm or less in which the nanoparticles are aggregated, and
the surfaces of the cellulose nanofibers are densely covered with the nanoparticles.

2. The composite material according to claim 1, wherein the composite material has a thermal conductivity in a plane direction of 3.0 W/m·K or more.

3. The composite material according to claim 1, wherein the nanoparticles are at least one selected from the group consisting of diamond, boron nitride, aluminum nitride, silicon nitride, silicon carbide, beryllium oxide, aluminum oxide, zinc oxide, magnesium oxide, silicon oxide, titanium oxide, aluminum hydroxide, and magnesium hydroxide.

4. The composite material according to claim 1, wherein the cellulose nanofibers have an aspect ratio of 50 to 200.

5. The composite material according to claim 1, wherein a mass ratio of the cellulose nanofibers to the nanoparticles of the composite material is 1:0.5 to 1:5.

6. A method for producing a composite material comprising cellulose nanofibers and nanoparticles, the method comprising:
continuously or sequentially mixing a suspension in which cellulose nanofibers are dispersed in a dispersion medium and a suspension in which nanoparticles are dispersed in a dispersion medium to obtain a composite material comprising the cellulose nanofibers and the nanoparticles,
wherein the structure of the nanoparticles is composed of primary nanoparticles with a particle diameter of 3 to 50 nm or aggregated nanoparticles with a particle diameter of 100 nm or less in which the nanoparticles are aggregated, and
the surfaces of the cellulose nanofibers are densely covered with the nanoparticles.

7. The production method of the composite material according to claim 6, wherein the dispersion medium is at least one selected from an aqueous solvent and an organic solvent.

8. The production method of the composite material according to claim 6, wherein a mixed solution of the suspensions at the time of continuously or sequentially mixing the suspensions is a dilute solution having a solid content of 3 mass % or less.

9. The production method of the composite material according to claim 6, wherein both of the suspensions are continuously or sequentially mixed into a base dispersion medium at the time of mixing the suspensions.

10. The production method of the composite material according to claim 6, wherein the suspension of the cellulose nanofibers has a solid content of 0.1 to 3 mass %, and the suspension of the nanoparticles has a solid content of 0.1 to 10 mass %.

11. The production method of the composite material according to claim 6, wherein a mixed solution of the suspensions has a pH of 4 to 9.

12. The production method of the composite material according to claim 6, wherein a high shearing force of 0.1 to 500 MPa is applied at the time of mixing the suspension of the cellulose nanofibers and the suspension of the nanoparticles.

13. The production method of the composite material according to claim 6, further comprising removing the dispersion medium of the composite material to obtain a dry thin film of the composite material in which the surfaces of the cellulose nanofibers are densely covered with the nanoparticles.

14. The production method of the composite material according to claim 13, wherein the dispersion medium of the composite material is removed by filtration.

15. The production method of the composite material according to claim 14, wherein the n the filtration is suction filtration or pressure filtration.

16. The production method of the composite material according to claim 14, further comprising pressing after the filtration.

17. A thermal conductive material comprising cellulose nanofibers and nanoparticles,
wherein the structure of the nanoparticles is composed of primary nanoparticles with a particle diameter of 3 to 50 nm or aggregated nanoparticles with a particle diameter of 100 nm or less in which the nanoparticles are aggregated, and
the surfaces of the cellulose nanofibers are densely covered with the nanoparticles.

18. The thermal conductive material according to claim 17, wherein the thermal conductive material has a thermal conductivity in a plane direction of 3.0 W/m·K or more.

19. The thermal conductive material according to claim 17, wherein the nanoparticles are at least one selected from the group consisting of diamond, boron nitride, aluminum nitride, silicon nitride, silicon carbide, beryllium oxide, aluminum oxide, zinc oxide, magnesium oxide, silicon oxide, titanium oxide, aluminum hydroxide, and magnesium hydroxide.

20. The thermal conductive material according to claim 17, wherein the cellulose nanofibers have an aspect ratio of 50 to 200.
